(19) United States
(12) Patent Application Publication
(10) Pub. No.: US 2014/0095991 A1
(43) Pub. Date: Apr. 3, 2014

(54) CONTENT REPRODUCTION APPARATUS, CONTENT REPRODUCTION METHOD AND CONTENT REPRODUCTION PROGRAM

(71) Applicants: Toshiyuki Abe, Osaka-shi (JP); Masayuki Shimada, Osaka-shi (JP); Yusuke Kurimoto, Osaka-shi (JP)

(72) Inventors: Toshiyuki Abe, Osaka-shi (JP); Masayuki Shimada, Osaka-shi (JP); Yusuke Kurimoto, Osaka-shi (JP)

(73) Assignee: SHARP KABUSHIKI KAISHA, Osaka-shi, Osaka (JP)

(21) Appl. No.: 14/122,964

(22) PCT Filed: Jun. 14, 2012
(86) PCT No.: PCT/JP2012/065238

§ 371 Date: Nov. 27, 2013

(30) Foreign Application Priority Data
Jun. 14, 2011 (JP) 2011-132640

(51) Int. Cl. G06F 17/21

(52) U.S. Cl. CPC G06F 17/211
USPC 715/255

(57) ABSTRACT

To provide a content reproduction apparatus, content reproduction method and content reproduction program that enable progress of browsing to be grasped with ease for each divided area in a single piece of content, a content reproduction apparatus that enables content to be reproduced from some midpoint is provided with a reproduction progress determination part 108 that identifies a reproduction position in entire content which is divided into a plurality of areas as a mark position when a predetermined condition is met, a table management part 106 that manages a table for associating the identified mark position with an area including the reproduction position among the divided areas, and a content reproduction part 102 that reproduces the content from the reproduction position corresponding to the table when instructions for reproduction from the mark position are given. By this means, it is possible to reproduce the content corresponding to progress of browsing within the area for each of the divided areas in a single piece of content.

### TECHNICAL FIELD

The present invention relates to a content reproduction apparatus, content reproduction method and content reproduction program that enable content to be reproduced from some midpoint.

### BACKGROUND ART

Electronic book terminals are configured to store content data obtained by converting contents of books into electronic form, display content data, and enable selection of content data desired to read, page turning and the like to be operated. Then, when desired content data is selected by operation, the terminal reads out the selected content data, and displays the first page of the main body data of the content data on a screen. Further, when instructions for the turn of a page are given in an operation input part, it is possible to switch the content data to the next page to display.

Such electronic book terminals enable consumption of resources to be suppressed, as compared with conventional paper books, are further convenient to carry since a single apparatus is capable of storing a plurality of items of data, and are easy to manage the books. Since the terminals thus have various advantages, in recent years, as well as terminals dedicated to electronic books, electronic book terminals in various forms have become widespread such as cellular telephones and PDA (Personal Digital Assistant).

In the conventional electronic book terminals, in the case of searching a large amount of content data for pages including a desired page on the display screen, adopted is the method of opening the content data, performing page feeding, page turning and the like while browsing, and arriving at the required page. Further, the terminals display a list screen of bookmark information called the bookmark list set by a user beforehand, the user selects a page to reproduce from the list screen to press an execution button, and the selected page is thereby displayed on the screen.

In such electronic book terminals, proposed is a terminal which automatically stores a stopped position as bookmark information when browsing of the content is stopped, enables browsing from the position of the content designated by the bookmark information to be resumed when browsing of the book is resumed, and thus enables the bookmark function to be used with ease (for example, see Patent Document 1).

### PRIOR ART DOCUMENT

### Patent Document

Patent Document 1: Japanese Unexamined Patent Publication No. 2007-148603

### DISCLOSURE OF INVENTION

### Problems to be Solved by the Invention

However, the content supposed to browse in the electronic book terminals as described is mainly general books. In contrast thereto, in the case of browsing content of a magazine, newspaper or the like, in reading another article after browsing up to some midpoint in the divided area of an article or the like, it becomes unable to recognize the some midpoint that is already read in the previous article. Further, in the case of browsing interest articles, it becomes unable to recognize which article is already read and which article is not read yet.

The present invention is made in view of such circumstances, and it is an object of the invention to provide a content reproduction apparatus, content reproduction method and content reproduction program that enable progress of browsing to be grasped with ease for each divided area in a single piece of content.

### Means for Solving the Problem

(1) To attain the above-mentioned object, a content reproduction apparatus of the present invention is a content reproduction apparatus that enables content to be reproduced from some midpoint, and is characterized by being provided with a reproduction progress determination part that identifies a reproduction position in entire content which is divided into a plurality of areas as a mark position when a predetermined condition is met, a table management part that manages a table for associating the identified mark position with an area including the reproduction position among the divided areas, and a content reproduction part that reproduces the content from the reproduction position corresponding to the table when instructions for reproduction from the mark position are given. By this means, it is possible to reproduce the content corresponding to progress of browsing within the area for each of the divided areas in a single piece of content.

(2) Further, the content reproduction apparatus of the invention is characterized in that when reproduction of content is finished, the reproduction progress determination part identifies a reproduction position at the time of the finish as a mark position. By this means, the position in which reproduction is finished is managed as a mark position, and such a mark position is managed for each of the divided areas.

(3) Furthermore, the content reproduction apparatus of the invention is characterized in that when the reproduction position shifts out of the area that is currently reproduced, the reproduction progress determination part identifies a reproduction position immediately before the shift as a mark position. By this means, since the mark position for each area is assigned when the position goes out of the area, it is possible to reproduce from some reproduction midpoint for each area.

(4) Still furthermore, the content reproduction apparatus of the invention is characterized in that the reproduction progress determination part identifies the degree of progress of reproduction within the divided area from the mark position in the divided area. By this means, it is possible to manage the degree of progress for each divided area to display, and therefore, the user is easier to grasp each degree of progress.

(5) Moreover, the content reproduction apparatus of the invention is characterized in that when reproduction of the content is finished, the reproduction progress determination part identifies a reproduction position at the time of the finish as mark position, while identifying the degree of progress of reproduction within the divided area from the mark position at the time of the finish. By this means, the degree of progress is managed in the position in which reproduction is finished for each of the divided areas.

(6) Further, the content reproduction apparatus of the invention is characterized in that when the reproduction position shifts out of the area that is currently reproduced, the reproduction progress determination part identifies a reproduction position immediately before the shift as a mark position, while identifying the degree of progress of reproduction within the divided area from the reproduction position immediately before the shift. By this means, the degree of progress is managed for each divided area when the position goes out of the area.

(7) Furthermore, the content reproduction apparatus of the invention is characterized in that the content reproduction part processes display due to reproduction of the content, and thereby performs reproduction progress display indicative of the degree of progress of the reproduction or the mark position for each divided area. By this means, for example, it is possible to grasp the progress of unread, already read or the like within the area for each of the divided area within the content. Further, it is possible to know a position to which the content is read for each area of display of the table of contents or pages with the headline put.

(8) Still furthermore, the content reproduction apparatus of the invention is characterized in that the content reproduction part adds the reproduction progress display onto display due to reproduction of the content to display. By this means, by using display of the content, it is possible to add the progress display onto the display to display.

(9) Moreover, the content reproduction apparatus of the invention is characterized in that the content reproduction part displays the divided areas on display of the table of contents of the content displayed due to reproduction of the content for each item of the table of contents, while performing the reproduction progress display for each item of the table of contents. By this means, for example, it is possible to display characters of “unread”, “already read” and “middle of browsing” on the side of the item of the table of contents as progress display, and the user is thereby easier to grasp progress for each area.

(10) Further, the content reproduction apparatus of the invention is characterized by being further provided with an operation input part that receives operation for giving instruction for reproduction of the content, where the operation input part receives operation for selecting the reproduction progress display, and the content reproduction part reproduces the content from the mark position associated with the selected reproduction progress display. By this means, for example, in the case where browsing of the divided area is in progress, it is possible to move promptly to the page of which browsing is in progress for each area.

(11) Furthermore, the content reproduction apparatus of the invention is characterized in that the content reproduction part changes a part of display due to reproduction of the content to perform the reproduction progress display. By this means, for example, it is possible to color the entire article headline or color the title of the headline corresponding to the progress of reproduction.

(12) Still furthermore, the content reproduction apparatus of the invention is characterized in that the content reproduction part rearranges an arrangement of display due to reproduction of the content to perform the reproduction progress display. By this means, for example, it is possible to rearrange articles for each degree of progress to display the rearranged headline page. By this means, it is possible to collect divided areas for each degree of progress to display.

(13) Moreover, a content reproduction method of the invention is a content reproduction method performed by a content reproduction apparatus to enable content to be reproduced from some midpoint, and is characterized by including a step of identifying a reproduction position in entire content which is divided into a plurality of areas as a mark position when a predetermined condition is met, a step of managing a table for associating the identified mark position with an area including the reproduction position among the divided areas, and a step of reproducing the content from the reproduction position corresponding to the table when instructions for reproduction from the mark position are given. By this means, it is possible to reproduce the content corresponding to progress of browsing within the area for each of the divided areas in a single piece of content.

(14) Further, a content reproduction program of the invention is a content reproduction program for causing a content reproduction apparatus to execute so as to enable content to be reproduced from some midpoint, and is characterized by including processing of identifying a reproduction position in entire content which is divided into a plurality of areas as a mark position when a predetermined condition is met, processing of managing a table for associating the identified mark position with an area including the reproduction position among the divided areas, and processing of reproducing the content from the reproduction position corresponding to the table when instructions for reproduction from the mark position are given. By this means, it is possible to reproduce the content corresponding to progress of browsing within the area for each of the divided areas in a single piece of content.

### Advantageous Effect of the Invention

According to the present invention, it is possible to grasp progress of reproduction for each of divided areas in a single piece of content.

### BRIEF DESCRIPTION OF DRAWINGS

FIG. 1 is a block diagram illustrating a configuration of an electronic book terminal (content reproduction apparatus) of the present invention;

FIG. 2 is a schematic diagram showing an example of content;

FIGS. 3(a) and 3(b) are diagrams showing examples of display images of a page of the table of contents of an Embodiment and Comparative Embodiment, respectively;

FIG. 4 is a flowchart illustrating a method of generating a mark position table;

FIG. 5 is a diagram showing an example of an area table;

FIG. 6 is a diagram showing an example of an ID table;

FIGS. 7(a) and 7(b) are diagrams each showing an example of the mark position table;

FIG. 8 is a schematic diagram illustrating the relationship of each table;

FIG. 9 is a flowchart illustrating operation for displaying progress of reproduction;

FIG. 10 is a diagram illustrating a display example of a page of a table of contents;

FIG. 11 is a flowchart illustrating operation for shifting to a mark position;

FIG. 12 is a flowchart illustrating operation for automatically adding a mark position;

FIG. 13 is a flowchart illustrating operation for updating the mark position table in association with a page shift;

FIG. 14 is a flowchart illustrating operation for displaying a page of the table of contents;

FIG. 15 is a diagram illustrating a configuration example of content;

FIG. 16 is a diagram illustrating a display example of a headline screen;

FIGS. 17(a) and 17(b) are diagrams showing examples of content data structure and area table, respectively;

FIG. 18 is a flowchart illustrating operation for storing content and generating the mark position table;

FIG. 19 is a diagram showing the mark position table;

FIG. 20 is a flowchart illustrating operation for displaying progress of reproduction on a headline;

FIGS. 21(a) and 21(b) are diagrams showing examples of the mark position table and headline page display associated with the table, respectively;

FIGS. 22(a) and 22(b) are diagrams showing display examples of reproduction progress display;

FIG. 23 is a diagram showing a display example of reproduction progress display;

FIG. 24 is a diagram showing another display example of reproduction progress display;

FIG. 25 is a flowchart illustrating operation after selecting an article in a headline page; and

FIG. 26 is a flowchart illustrating operation for adding a mark position.

### BEST MODE FOR CARRYING OUT THE INVENTION

Embodiments of the present invention will be described next with reference to drawings.

### DEFINITIONS OF TERMS

In the following description, “content data” refers to data obtained by converting mainly books including magazines, newspapers and the like to electronic formats, and may include moving image data and the like. As an example of divided areas in content, articles are used to explain, and as other divided areas, chapters, sections, columns or paragraphs, or areas divided by an author or user (browser) may be used. Further, the content reproduction apparatus is capable of reproducing content divided into a plurality of areas, the processing on such content is the feature of the invention, and it is also possible to reproduce other content that is not divided.

Further, a “content reproduction apparatus” is explained using an electronic book terminal as a preferable example. However, the content reproduction apparatus is not limited thereto. As well as the terminal, a cellular telephone, PHS, PDA, personal computer, game machine, television and the like may be used, and an apparatus capable of connecting to a network is preferable. In addition, operation of the content reproduction apparatus is performed by execution of a program.

“Information of the mark position” is data indicative of a reproduction position in the content. The reproduction position is represented by designating the number of bytes or the like of a page, character, image or data or the like. The information of the mark position is included in a mark position table. In Embodiment 1 the information of the mark position is mark position columns of a mark position table, and in Embodiment 2 the information of the mark position is mark position columns of a mark position table. In addition, the position corresponds to a page in electronic book content.

Further, a “mark position addition part” generates and stores the information of the mark position. The mark position addition part is configured to write the information of the mark position in the mark position table to store in a table storage part. “Display of the table of contents” is display indicative of contents of the content. For example, the “display of the table of contents” is a page of the table of contents or a headline page of a newspaper. Further, an “item of the table of contents” is an item indicative of content in the content within the display of the table of contents.

### Embodiment 1

(Configuration Example of the Electronic Book Terminal)

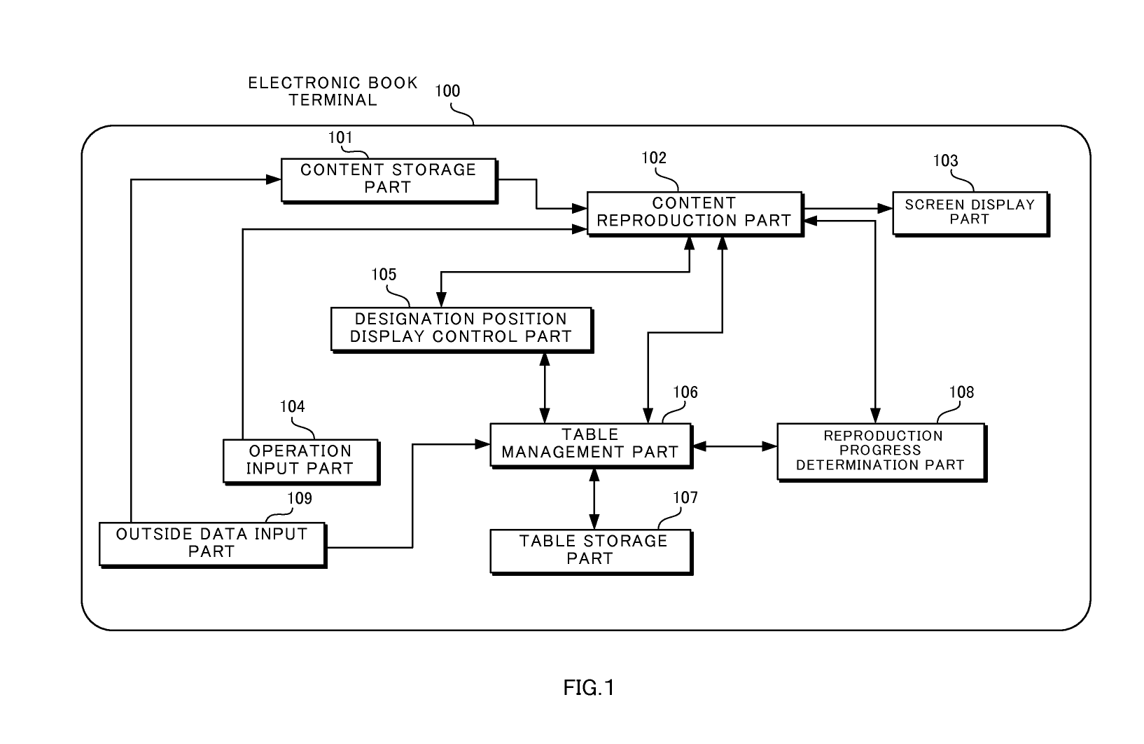

FIG. 1 is a block diagram illustrating a configuration of an electronic book terminal (content reproduction apparatus) 100. As shown in FIG. 1, the electronic book terminal 100 is provided with a content storage part 101, content reproduction part 102, screen display part 103, operation input part 104, designation position display control part 105, table management part 106, table storage part 107, reproduction progress determination part 108, and outside data input part 109.

The content storage part 101 stores content data. The content reproduction part 102 receives the content data stored in the content storage part 101 and information of the degree of progress that the table management part 106 reads from the table storage part 107, by instruction of the operation input part 104 and designation position display control part 105. Then, based on a content image presented by a user corresponding to the information of the degree of progress, the part 102 generates a screen image to actually display on a screen to deliver to the image display part 103. In this way, when instructions for reproduction from the mark position are given, the content is reproduced from the reproduction position corresponding to the table.

Further, the content reproduction part 102 processes display due to reproduction of the content, and thereby performs progress display indicative of the degree of progress of reproduction or the mark position for each of divided areas of the content. For example, it is possible to add reproduction progress display onto display due to reproduction of the content to display, change a part of display due to reproduction of the content to perform reproduction progress display, or rearrange the arrangement of display due to reproduction of the content to perform reproduction progress display.

The screen display part 103 receives the screen image from the content reproduction part 102 to display on the screen. The display is included in reproduction. The operation input part 104 receives operation input from the user. For example, the part 104 receives input of page designation of the content to display on the screen. The designation position display control part 105 receives mark position information or article area information that the table management part 106 reads from the table storage part 107, and delivers display page information to the content reproduction part 102.

The table management part 106 makes information of the reproduction position the information of the mark position, and stores information associated with the area of the content being reproduced, information of the degree of progress, and the information of the mark position in the table storage part 107. The table storage part 107 stores the area information, the information of the mark position and the information of the degree of progress associated with the content data stored in the content storage part 101.

The reproduction progress determination part 108 reads the information of the reproduction position in the entire content from the content reproduction part 102, and the area information that the table management part 106 reads from the table storage part 107, and determines the area and degree of progress of the content being reproduced. Further, the part 108 makes the reproduction position the mark position, and associates the area being reproduced, the information of the degree of progress with the information of the mark position to deliver to the table management part 106. Identification of the mark position is performed when a predetermined condition is met.

For example, when reproduction of the content is finished, the reproduction progress determination part 108 identifies the reproduction position at the time of the finish as the mark position. Further, when the reproduction position shifts out of the area that is currently reproduced, the part 108 identifies the reproduction position immediately before the shift as the mark position.

The outside data input part 109 receives the content data and a table indicative of page areas of articles in the content from outside the electronic book terminal 100 to deliver to the content storage part 101 and table management part 106.

[Configuration of Content]

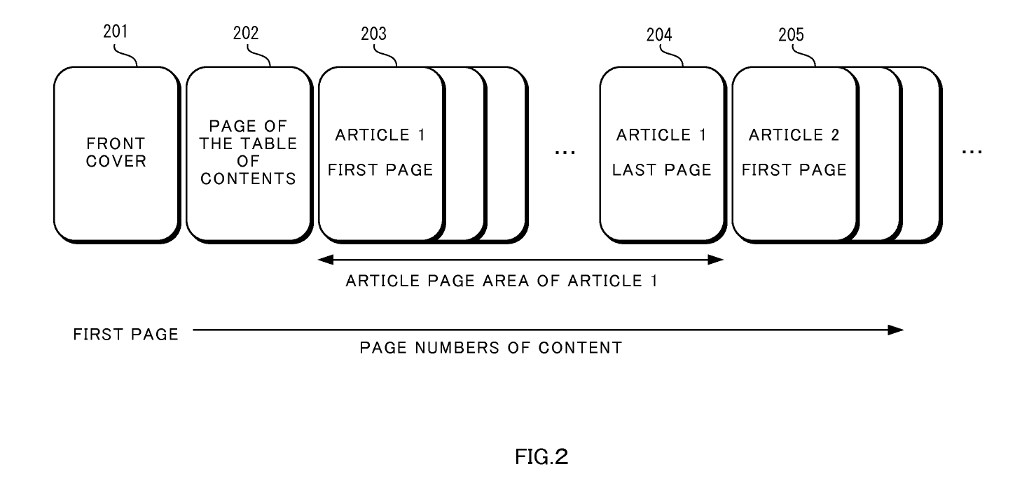

FIG. 2 is a schematic diagram showing an example of content. Rectangles in the figure represent respective pages in the content. Further, the left side represents pages at the beginning of the content. A first page 201 is the front cover. From this page, page of the table of contents 202, and further, articles are continued successively. The article page area is indicated by the first page and last page of each article. For example, the article page area of an article 1 refers to from a first page 203 to last page 204 of the article 1. In addition, a page such as the front cover, the table of contents page and advertisement that do not belong to the article may be inserted in between pages.

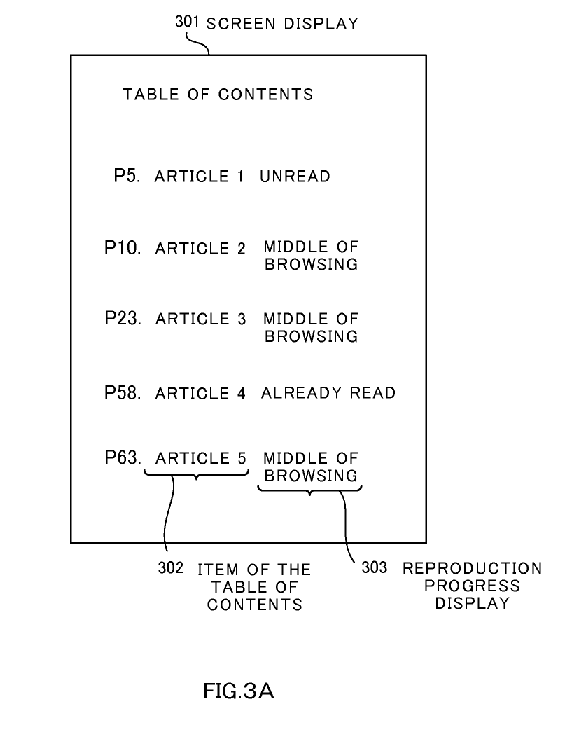

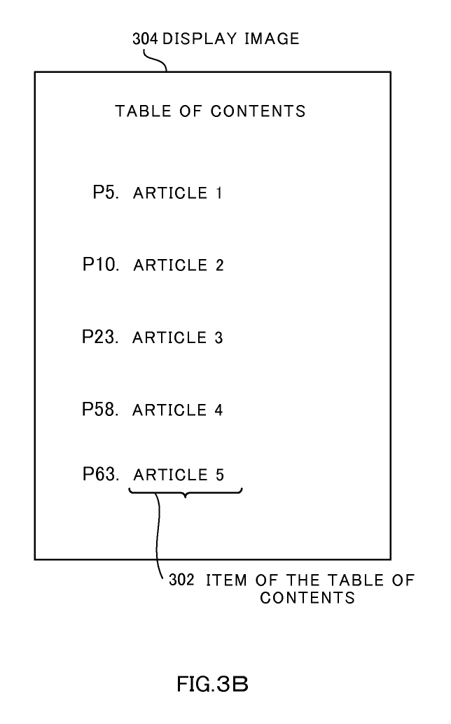

FIGS. 3(a) and 3(b) are diagrams showing examples of display images of a page of the table of contents of an Embodiment and Comparative Embodiment, respectively. The page of the table of contents 202 displays information of articles that the content has, a page from which the article starts and the like. The information is called an item of the table of contents 302. A display image 304 is the page of the table of contents displayed by using only the content data, and shows the Comparative Embodiment. The electronic book terminal 100 performs screen display 301 of the display image.

Reproduction progress display 303 is display to convey the degree of progress of content reproduction or the mark position. The reproduction progress display 303 is not display of data included in the content data, but is display added onto display of the content. Details of the reproduction progress display 303 will be described later.

[Table Generation]

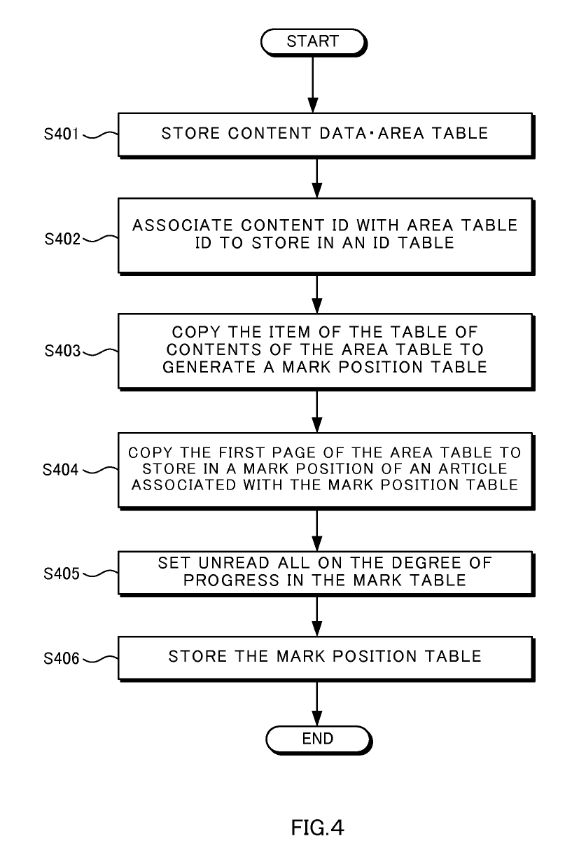

FIG. 4 is a flowchart illustrating a method of generating a mark position table. As shown in FIG. 4, the electronic book terminal 100 stores the information of the mark position corresponding to the content.

First, the outside data input part 109 receives the content data from outside the electronic book terminal 100, and stores the content data in the content storage part 101. Then, the part 109 delivers a table that associates the item of the table of contents with an article page area (divided area of the content) of the item of the table of contents to the table management part 106. The table management part 106 stores the received table in the table storage part 107 (step S401). Hereinafter, the table indicative of correspondence between the item of the table of contents and the article page area of the item of the table of contents is called an area table 500.

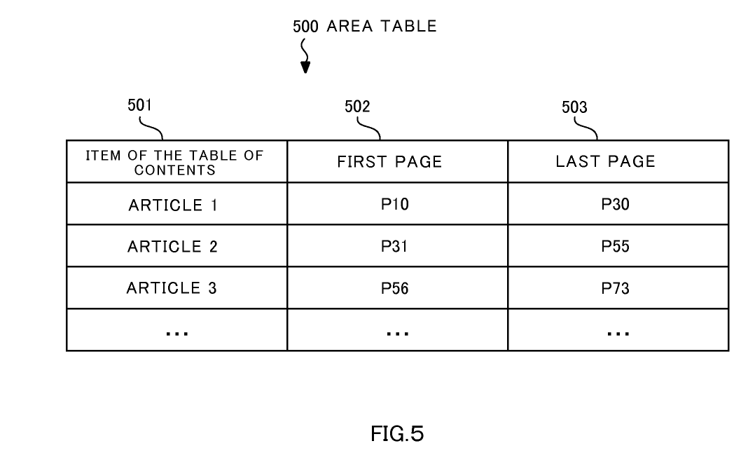

FIG. 5 is a diagram showing an example of the area table 500. The article page area is indicated by a first page 502 and last page 503 of the article. Further, the outside data input part 109 delivers a content ID for uniquely identifying the above-mentioned stored content and an area table ID for uniquely identifying the above-mentioned area table 500 to the table management part 106.

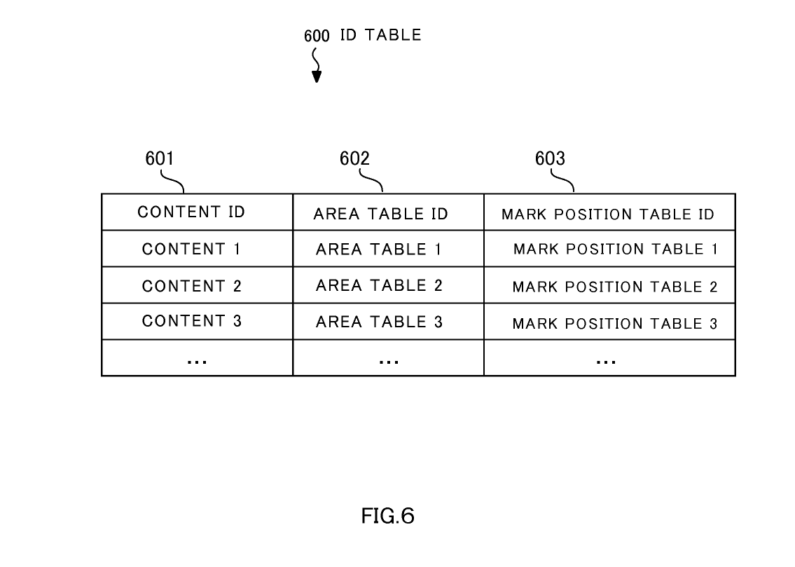

When storage of the area table 500 is finished, the table management part 106 generates a table that associates the content ID with the area table ID to store in the table storage part 107 (step S402). Hereinafter, the table is referred to as an ID table. FIG. 6 is a diagram showing an example of the ID table. The ID table 600 is comprised of a content ID column 601, area table ID column 602, and mark position table ID column 603, and shows the correspondence among IDs. As the ID table, a single ID table is set on a single electronic book terminal 100, and when other content is stored in the electronic book terminal, the content is written in the ID table.

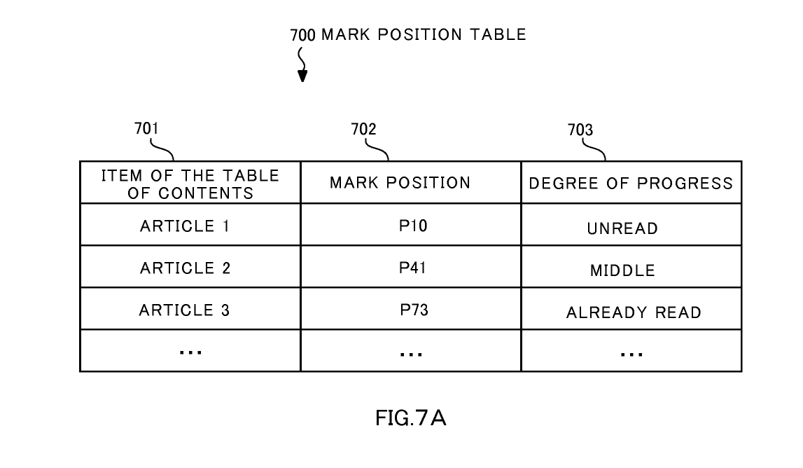

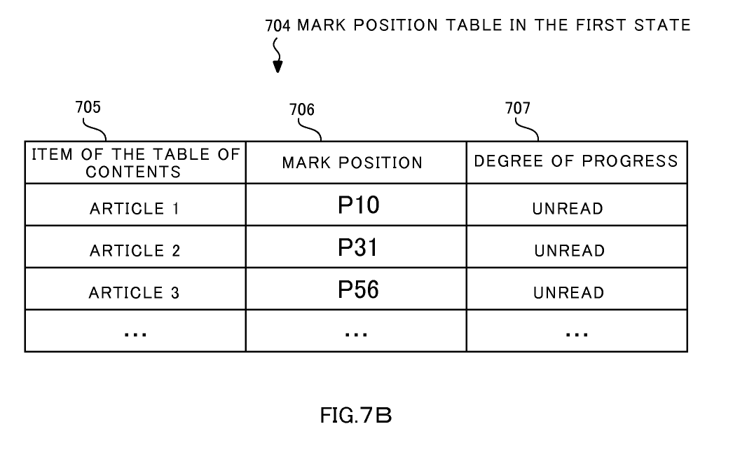

Each of FIGS. 7(a) and 7(b) is a diagram showing an example of the mark position table. The table management part 106 generates the mark position tables as shown in FIGS. 7(a) and 7(b) (step S403). The table management part 106 reads an item of the table of contents column 501 of the area table 500 from the table storage part 107. Then, the part 106 generates a table comprised of a copied item of the table of contents column 701, mark position column 702 indicative of the mark position associated with each article of the item of the table of contents, and a degree of progress column 703 for each article. Hereinafter, the table is referred to as a mark position table 700. Further, the table management part 106 generates a unique mark position table ID indicative of the mark position table, associates the content ID with the area table ID to write in the ID table, and stores the table in the table storage part 107.

The table management part 106 copies the column of the first page 502 of the area table 500 to the mark position column 702 of the mark position table 700 (step S404), and makes the initial state of the mark position the first page of the article. Further, the table management part 106 sets unread on all items of the degree of progress column 703 of the mark position table 700 (step S405), and stores the mark position table 700 in the table storage part 107 (step S406).

FIG. 7(b) is a diagram showing an example of the mark position table in a first state. As shown in FIG. 7(b), the mark position table in the first state is generated by the above-mentioned generation function. A table 704 is the table that is generated using the area table 500 in FIG. 5. An item of the table of contents column 705 is the same as the item of the table of contents column 501, and on a mark position column 706 are set the same pages of the column of the first page 502 of the area table. A degree of progress column 707 is all set for an unread state.

Herein, any order can be applied to the processing for generating items in the item of the table of contents column 701, mark position column 702 and the degree of progress column 703 of from steps S403 to S405. Further, generation of the mark position table 700 can be performed at any time for a period during which the content data is stored in the electronic book terminal 100 and then, the content data is first reproduced. Furthermore, the generation may be performed for a period during which the content data is opened, and then, the table of contents page or article is reproduced.

(The Case of Retrieving the Mark Position Table from Outside)

The mark position table may be received from outside the electronic book terminal 100 together with the content and area table. In this case, the mark position table is stored in the table storage part 107 as well as the area table.

(Relationship Between Tables)

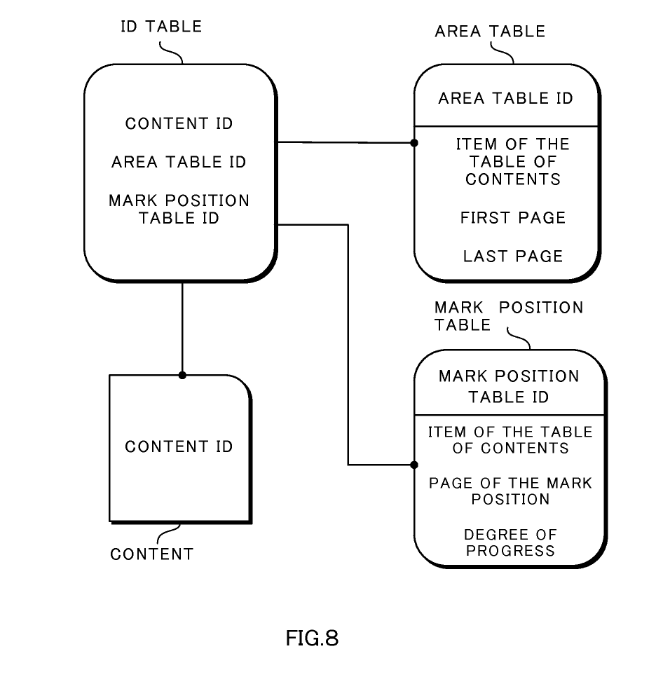

FIG. 8 is a schematic diagram illustrating the relationship of each table. Described are relationships among the content, ID table, area table and mark position table. The content, area table and mark position table are generated corresponding to the number of pieces of content. A single ID table is generated for the electronic book terminal. The content is uniquely assigned the content ID, the area table is uniquely assigned the area table ID, and the mark position table is uniquely assigned the mark position table ID. It is possible to extract the area table and the mark position table associated with the content by referring to correspondence of each ID identified in the ID table.

[Generation of the Table of Contents]

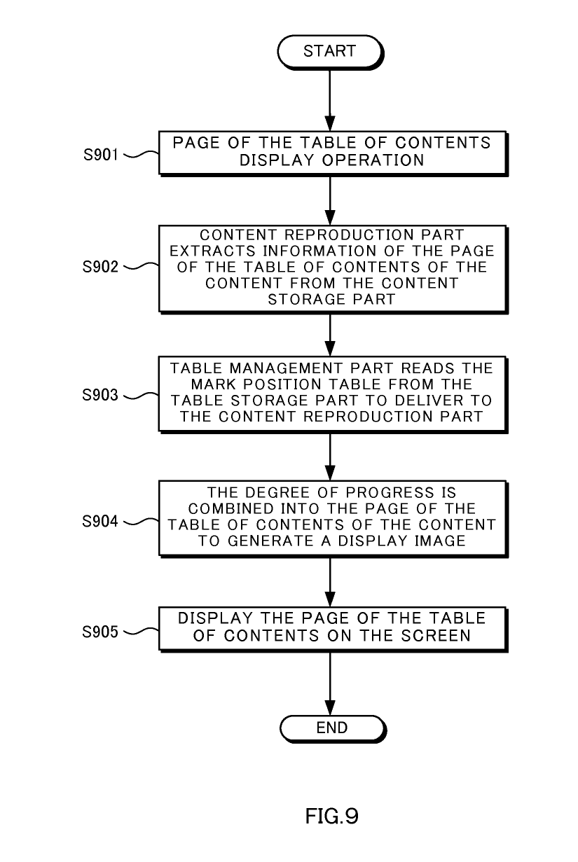

FIG. 9 is a flowchart illustrating operation for displaying the degree of progress. As shown in FIG. 9, the degree of progress for each article is displayed on a page of the table of contents in reproducing the content. First, a user performs the page of the table of contents display operation using the operation input part 104 (step S901), and the information is sent to the content reproduction part 102. At this point, timing at which the user performs the page of the table of contents display operation can be before reproduction of the content or during reproduction of the content.

(Readout of Corresponding Table from Table ID)

Next, the content reproduction part 102 receiving the information for performing the table of contents display extracts content information of the page of the table of contents from the content storage part 101 (step S902). The table management part 106 receives the ID of the content being reproduced from the content reproduction part 102, and reads the ID table from the table storage part 107. Then, the part 106 acquires the mark position table ID associated with the content being reproduced, and reads the mark position table 700 indicated by the mark position table ID from the table storage part 107 to deliver to the content reproduction part 102 (step S903). Thereafter, unless otherwise specified, the part 106 reads the table associated with the content being reproduced from the ID table in the same way in operating the mark position table or the area table.

Then, the content reproduction part 102 generates a display image for displaying an item of the degree of progress 703 of the mark position table 700 received from the table storage part 107 in a corresponding item of the table of contents of the page of the table of contents in the content information of the page of the table of contents received from the content storage part 101 (step S904). The content reproduction part 102 delivers the display image to the screen display part 103, and the screen display part 103 displays on the screen (step S905).

(Comparison with the Case of not Displaying the Degree of Progress)

FIG. 3 is a screen display example of the page of the table of contents of content. The page of the table of contents is displayed within the screen display 301. As comparison, shown is a comparative example of only content data without performing reproduction progress display. FIG. 3 shows the display image 304 of the page of the table of contents. The item of the table of contents 302 is an item of the table of contents generated with the content data. The reproduction progress display 303 is display of the degree of progress for each item of the table of contents generated by the content reproduction part 102 from the mark position table 700. As shown in FIG. 3, it is possible to display characters of “unread”, “already read” or “middle of browsing” as reproduction display 303 on the side of the item of the table of contents 302 according to the degree of progress.

At this point, the reproduction progress display 303 may be other display which is capable of displaying the degree of progress. For example, other character strings such as “read”, “not read” and “middle of reading” indicative of the same meaning may be used. Instead of character lines, percentage display indicative of the degree of progress, progress bar display or the like may be used.

The degree of progress may be represented by changing the character color of the item of the table of contents. For example, it is conceivable that character color red is unread, blue is the middle of browsing, and that black is already read. Further, the degree of progress may be represented by the character size of the item of the table of contents or image size. For example, it is conceivable that the unread item of the table of contents is made the size larger than the designated in the content, the item of the table of contents in the middle of browsing is made the designated size, and that the already read item of the table of contents is made the size smaller than the designated character size. Alternatively, the progress may be represented by changing the concentration of the item of the table of contents.

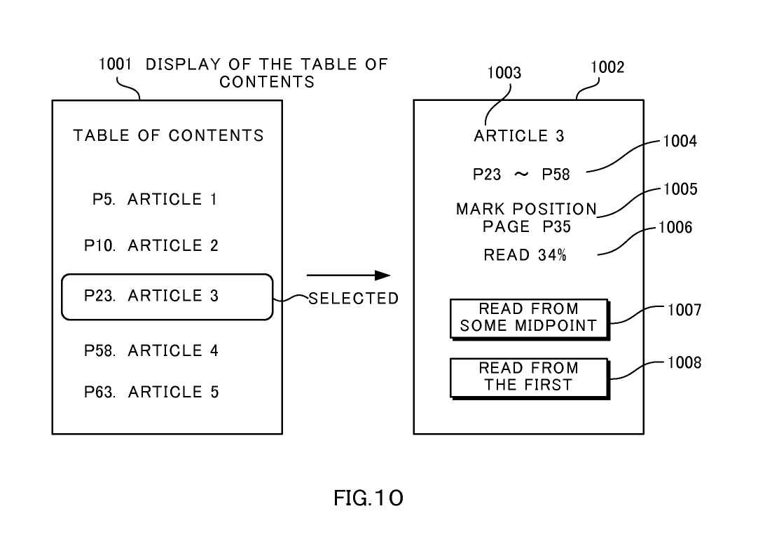

Further, the degree of progress may not be displayed on the image of the page of the table of contents from the beginning together with display of the page of the table of contents. For example, in a terminal mounted with a touch panel, reproduction progress display may be made after selecting the item of the table of contents to touch. As well as the reproduction progress display, the page of the mark position and a selection item to shift to the first page of the article may be displayed at the same time. FIG. 10 is a diagram showing a display example of the page of the table of contents. A screen display example 1001 is to display the page of the table of contents reproduced with the content data. Herein, when the item of the table of contents is selected, the content reproduction part 102 generates a display image of reproduction progress detail display 1002 from the information of the area table 500 and the mark position table 700, and the screen display part 103 receiving the image displays on the screen. On the reproduction progress detail display 1002 are displayed a selected item of the table of contents 1003, page area 1004 of the item of the table of contents, mark position 1005, display 1006 of the degree of reproduction progress, a selection item 1007 to read from the mark position, and a selection item 1008 to read from the first of the article. In the case of selecting the selection item 1008 to read the article of the selected item of the table of contents from the beginning, step 1106 described later or in the case of selecting the selection item 1007 to read from the mark position of the article of the selected item of the table of contents, operation of step S1105 described later is performed. Display of these items may be displayed by long press or operation for displaying a menu in the terminal mounted with the touch panel.

[Selection of The Table of Contents]

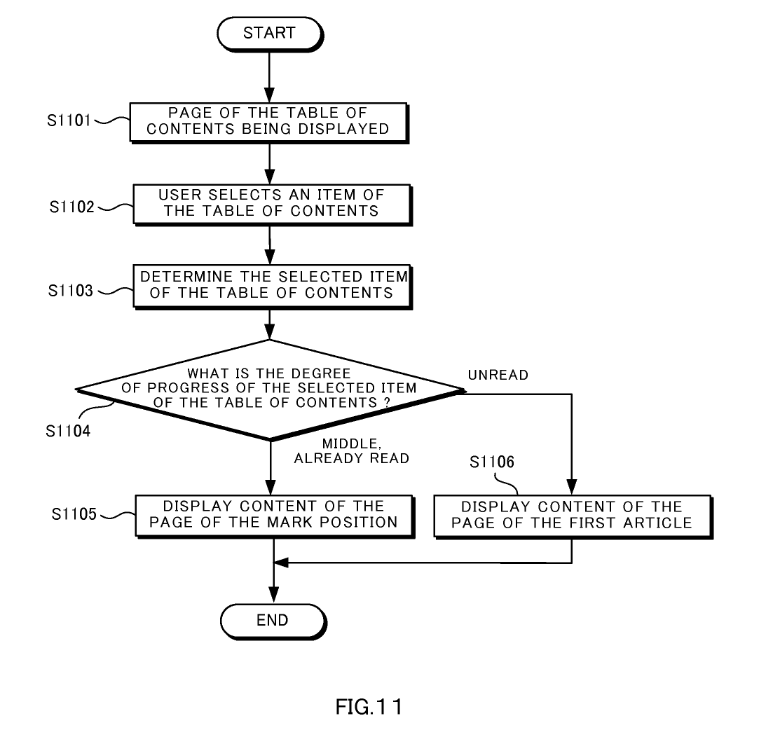

FIG. 11 is a flowchart illustrating operation for shifting to a mark position. As shown in FIG. 11, a shift is performed from the item of the table of contents on the page of the table of contents to the mark position of each article. As an example, it is assumed that the page of the table of contents as shown in FIG. 3(a) is displayed (step S1101). The user is capable of selecting an item of the table of contents displayed on the screen or the degree of progress displayed on the side of the item of the table of contents by inputting operation from the operation input part 104.

When the user selects an item of the table of contents that the user wants to browse, the operation input part 104 sends the selected position information on the screen to the content reproduction part 102 (step S1102). The content reproduction part 102 determines the selected item of the table of contents from the position information (step S1103), and delivers the selected item of the table of contents to the designation position display control part 105.

By instructions of the designation position display control part 105, the table management part 106 reads the mark position table 700 from the table storage part 107 to deliver to the designation position display control part 105. The designation position display control part 105 reads the degree of progress of the selected item of the table of contents, and determines whether the degree of progress is the middle of browsing, already read or unread (step S1104).

When the degree of progress is the middle of browsing or already read, the designation position display control part 105 instructs the content reproduction part 102 to display content of the page of the mark position of the selected item of the table of contents of the mark position table 700. The content reproduction part 102 reads the content information of the designated page from the content storage part 101, and generates the display image to deliver to the screen display part 103. The screen display part 103 displays the information on the screen (step S1105).

When the degree of progress is unread, by instructions of the designation position display control part 105, the table management part 106 reads the area table 500 from the table storage part 107 to deliver to the designation position display control part 105. The designation position display control part 105 reads the first page of the selected item of the table of contents of the area table 500, and delivers the content of the page to the content reproduction part 102. The content reproduction part 102 reads the content information of the designated page from the content storage part 101, and generates the display image to deliver to the screen display part 103. The screen display part 103 displays the information on the screen (step S1106).

[Automatic Mark Position Addition]

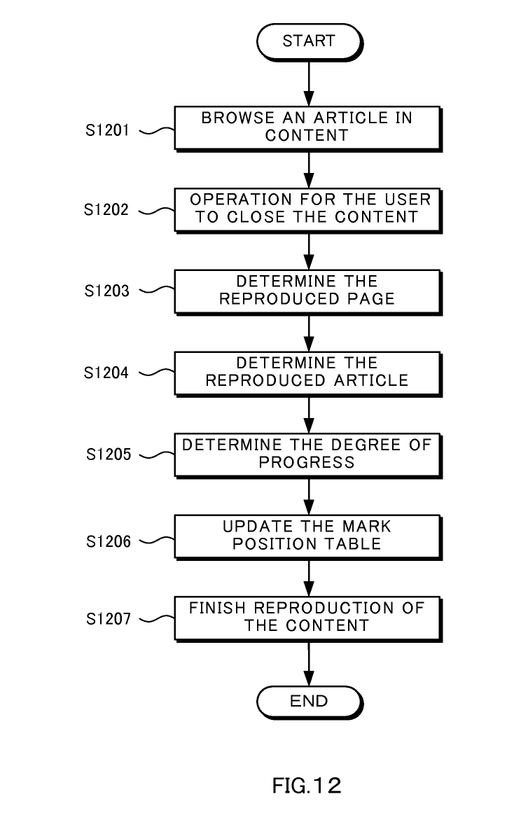

FIG. 12 is a flowchart illustrating operation for automatically adding a mark position. First, the electronic book terminal 100 reproduces an article in the content, and the content is browsed by a user (step S1201). Then, the operation input part 104 receives operation for the user to close the content (step S1202). The operation input part 104 delivers instructions for the content to be closed to the content reproduction part 102.

The content reproduction part 102 delivers the page being reproduced to the reproduction progress determination part 108. The reproduction progress determination part 108 determines the reproduced page (step S1203). By instructions of the reproduction progress determination part 108, the table management part 106 reads the area table 500 from the table storage part 107 to deliver to the reproduction progress determination part 108.

The reproduction progress determination part 108 compares the page being reproduced with the area table 500, and determines which article the user reproduces (step S1204).

Further, the part 108 compares the page being reproduced with the last page 503 written in the area table 500 of the article being reproduced. When the page being reproduced is before the last page, the part 108 determines that the degree of progress is “middle”, while when the page being reproduced is the same as the last page, determining that the degree of progress is “already read” (step S1205).

The reproduction progress determination part 108 delivers the article and page being reproduced and the information of the degree of progress to the table management part 106. Using these pieces of information, the table management part 106 updates the page of the mark position of the corresponding article of the mark position table 700 to the page being reproduced, while updating the degree of progress to the determined degree to store in the table storage part 107 (step S1206). In the case where the degree of progress is already read, the page in the mark position may be the first page of the corresponding article area. The table management part 106 conveys that the storage is finished to the content reproduction part 102, and the content reproduction part 102 finishes reproduction of the content (step S1207).

In addition, in step S1205, the degree of progress may be determined by the rate of reproduction progress such as percentage. In this case, in step S1205, the reproduction progress determination part 108 calculates the rate of reproduction progress from the first page 502, last page 503 and the page being reproduced in the area table 500. As an example of calculation, there is [(page being reproduced−first page)/(last page−first page)×100[%]]. Further, in step S1206, the reproduction progress determination part 108 delivers the degree of progress to the table management part 106 together with the article being reproduced. The table management part 106 stores the degree of progress as the information of the degree of progress of the corresponding article of the mark position table 700.

(Determination of a Shift of Article)

Herein, update of the above-mentioned mark position table 700 may be made not only in closing the content but also in finishing reading the article and reproducing the next article, or in shifting to a page except the article being reproduced.

In order to perform update in the case of reproducing the next article or in the case of shifting to a page except the article being reproduced, it is necessary to determine what the article being reproduced is whenever turning the page. Described below is operation of the determination part and mark position table update part in this case.

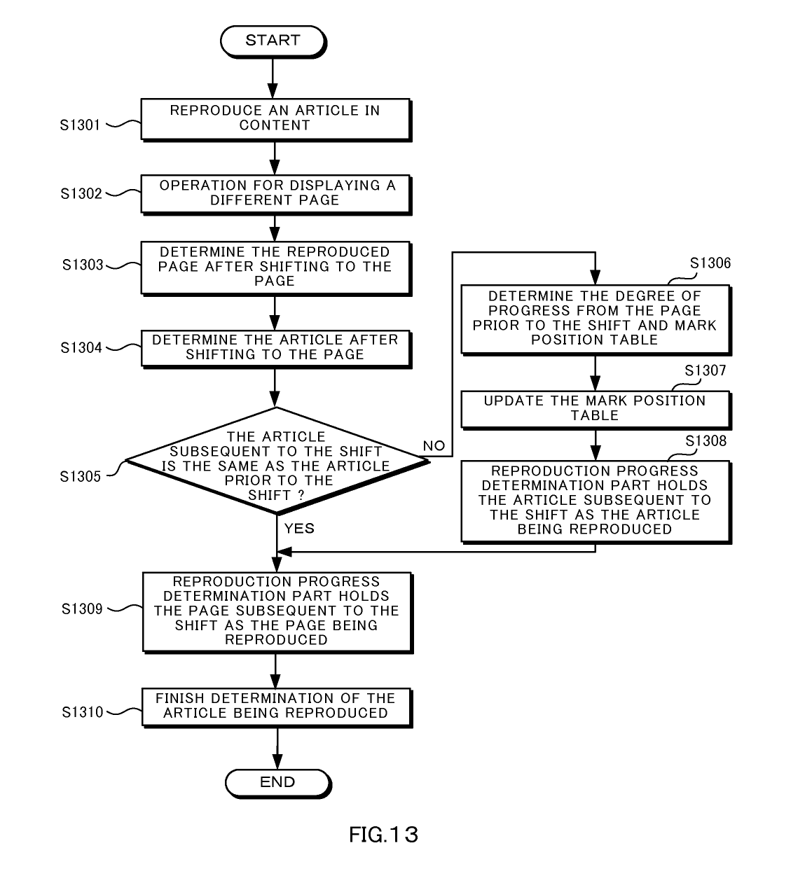

FIG. 13 is a flowchart illustrating operation for updating the mark position table in association with a page shift. First, in starting reproduction of the content, the content reproduction part 102 notifies the reproduction progress determination part 108 of the page being reproduced at the start time. Upon receiving the page being reproduced, the reproduction progress determination part 108 receives the area table 500 from the table storage part 107 via the table management part 106 to hold. Further, the reproduction progress determination part 108 determines the article being reproduced from the page being reproduced and the area table, and holds three pieces of information i.e. the page being reproduced, article being reproduced and area table.

It is assumed that the electronic book terminal 100 reproduces the content and that the user browses the content based on the premise (step S1301). The user performs page shift operation for displaying a different page from the operation input part 104 (step S1302). The operation input part 104 delivers the operation content to the content reproduction part 102. The content reproduction part 102 determines the page to display by the operation (step S1303).

The content reproduction part 102 delivers the page to display next to the reproduction progress determination part 108. The reproduction progress determination part 108 determines the article to reproduce after shifting to the page using the information of the held area table (step S1304).

The reproduction progress determination part 108 determines whether the article prior to the shift that is held as the article being reproduced is the same as the article subsequent to the shift (step S1305). When the articles are not the same, the reproduction progress determination part 108 determines the degree of progress from the page prior to the shift held as the page being reproduced and the area table (step S1306). The table management part 106 receives the information of the page prior to the shift, article prior to the shift and the degree of progress from the reproduction progress determination part 108, and updates the mark position table 700 in the table storage part 107 (step S1307). Then, the reproduction progress determination part 108 holds the article subsequent to the shift as the article being reproduced (step S1308) to proceed to step S1309.

Meanwhile, in the case of determining that the article prior to the shift that is held as the article being reproduced is the same as the article subsequent to the shift, the reproduction progress determination part 108 holds the page subsequent to the shift as the page being reproduced (step S1309), and finishes determination of the article being reproduced and mark position table update (step S1310).

Further, reproduction of the article such that the degree of progress is once already read is reproduced again, and the degree of progress may not be updated to be still already read in finishing reproduction of the article. Alternatively, the degree of progress may be made “re-browsing” indicative of reproduction again, and display meaning the middle of re-browsing may be made on reproduction progress display to display in the page of the table contents.

[Others]

Readout of the mark table ID and readout of the area table ID may be performed at the time of starting content reproduction. In this case, when operation for starting content reproduction is performed by the user from the operation input part 104, the information is sent to the content reproduction part 102. The content reproduction part 102 reads the content indicated by the user from the content storage part 101, and delivers the content ID to the table management part 106. The table management part 106 reads the ID table from the table storage part 107, and holds the mark position table ID and area table ID associated with the content ID.

Thereafter, the table management part 106 holds the mark position table ID and area table ID until finish of reproduction of the content being reproduced, reads the mark position table and area table to rewrite, and when receiving instructions for storage, performs the operation on the mark position table and area table indicated by the mark position table ID and the area table ID.

(Case of Determining the Degree of Progress in Generating the Table of Contents)

In the above-mentioned example, the determination of the degree of progress is made in adding the mark position, and the determination may be made on the degree of progress in displaying the page of the table of contents. In this case, the determination of the degree of progress in step S1205 is not made in adding the mark position, and in mark position table update in step S1205, the mark position column 702 of the corresponding article is only updated.

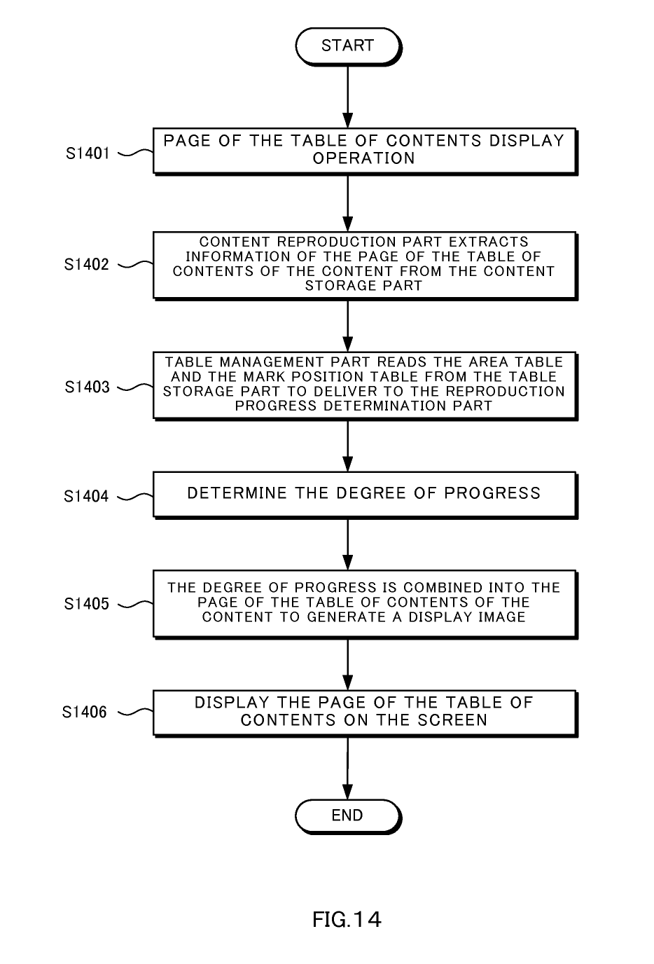

Described next is operation for displaying the page of the table of contents in the case of determining the degree of progress in displaying the page of the table of contents. FIG. 14 is a flowchart illustrating operation for displaying the page of the table of contents. First, the user performs operation for displaying the table of contents via the operation input part 104, and the information is sent to the content reproduction part 102 (step S1401). At this point, timing at which the user performs operation for displaying the table of contents can be before reproduction of the content or during reproduction of the content.

Next, the content reproduction part 102 receiving the information to perform display of the table of content extracts the content information of the page of the table of contents from the content storage part 101 (step S1402). The table management part 106 receives the content ID of the content being reproduced from the content reproduction part 102, and reads the area table 500 and mark position table 700 associated with the content ID from the table storage part 107 to deliver to the reproduction progress determination part 108 (step S1403).

The reproduction progress determination part 108 determines the degree of progress from the area table 500 and mark position table 700 for each article (step S1404). The determination method is the same as described above. The reproduction progress determination part 108 rewrites the degree of progress column 703 of the mark position table of the corresponding article to the determined degree of progress.

The content reproduction part 102 generates a display image for displaying an item of the degree of progress column 703 of the mark position table 700 received from the reproduction progress determination part 108 in a corresponding item of the table of contents of the page of the table of contents in the content information of the page of the table of contents received from the content storage part 101 (step S1405). The screen display part 103 receives the display image from the content reproduction part 102 to display on the screen (step S1406).

### Embodiment 2

In Embodiment 1, the page of the table of contents is displayed on display of the table of contents of the content, and in content of a newspaper or the like, instead of the page of the table of contents, there is the case of displaying a page with headlines put as display of the table of contents. According to this Embodiment, also in such a case, it is possible to know a position up to which an article is read for each article. In addition, the configuration of the electronic book terminal 100 used in Embodiment 2 is the same as that of the Embodiment 1.

[Content Configuration Example]

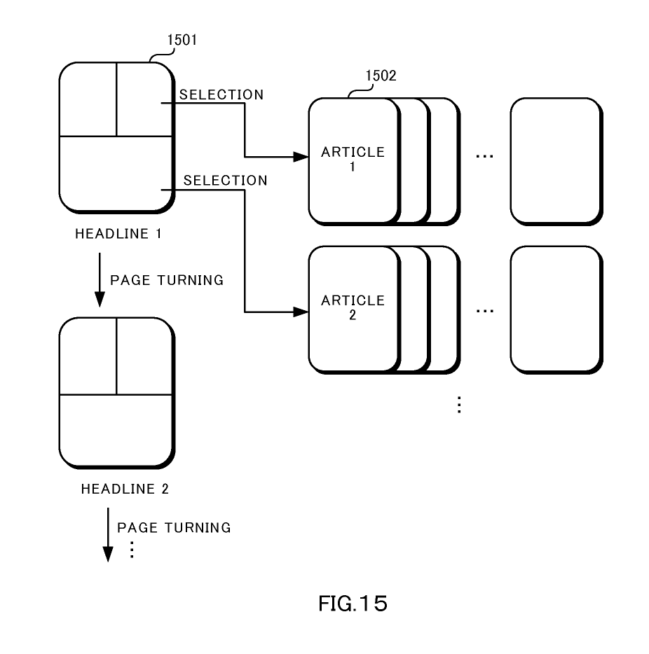

FIG. 15 is a diagram showing a configuration example of content. The content includes a screen 1501 to display headlines, and screens 1502 to display articles. When a headline of an article on the headline screen 1501 is selected, the screen 1502 of the article is displayed. There is a single or a plurality of headline screens, and in the case of a plurality of screens, by operation for turning the page, scrolling or the like, the next headline screen is displayed.

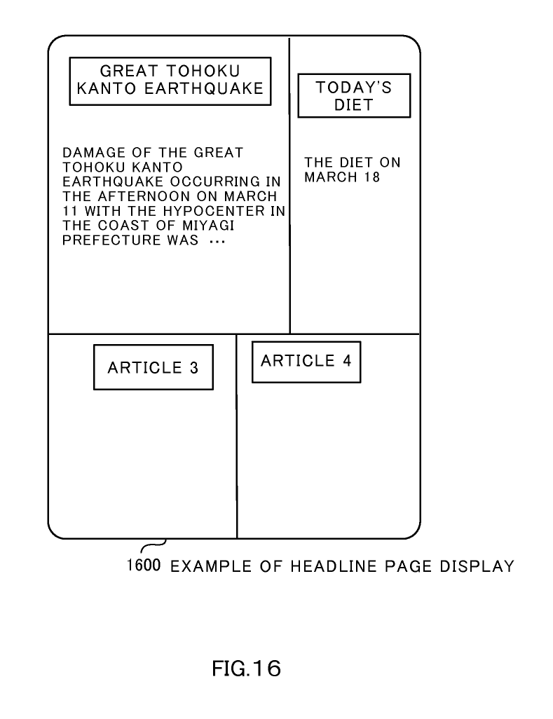

FIG. 16 is a diagram illustrating a display example of the headline screen. As shown in FIG. 16, the electronic book terminal 100 may divide the screen to display a plurality of article headlines. In this case, each headline corresponds to an item of the table of contents.

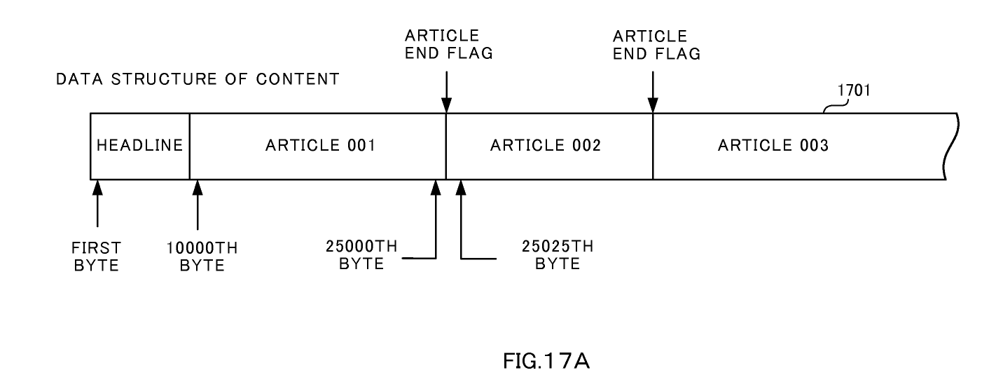

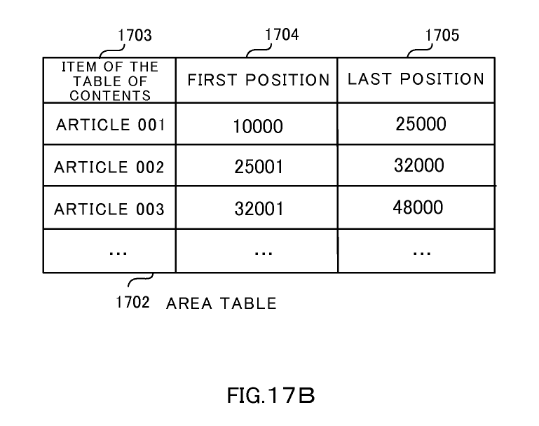

Further, FIGS. 17(a) and 17(b) are diagrams showing examples of data structure and area table, respectively. The content data is configured so that the headline, article 001, article 002 and the like are arranged in this order from the beginning. In the case of performing headline display as shown in FIG. 16, the headline portion of a data structure 1701 is read to display. The headline portion is provided with link information to each article and article ID, and in the case where an article is selected from the headline portion, the electronic book terminal 100 reads data of a portion of the corresponding article to display. Further, a flag of article end is provided between items of data of respective articles. By this means, in the case where the last portion of the article 001 is displayed, it is possible to perform control for not displaying the next data. In other words, in this case, content of the article 002 is not displayed continuously after the article 001.

(Explanation of the Area Table)

An area table 1702 is information that associates the article ID as an item of the table of contents 1703 with a first position 1704 and a last position 1705 as an area of the article data. The first position 1704 and last position 1705 correspond to the data structure 1701 of the content data, and are stored as information of the position of the byte number. The first position 1704 indicates the byte number from which the article starts, and the last position indicates the byte number at which the article ends. In the example as shown in FIG. 17, the article 001 is stored in from a 10000th byte to 25000th byte as shown in the data structure 1701. Accordingly, “10000” and “25000” are shown respectively in the first position 1704 and last position 1705 associated with the article 001 of the area table 1702.

(Content Acquisition and Table Generation (Update))

With reference to FIGS. 17, 18 and 19, details are described on operation for acquiring content from outside the electronic book terminal 100 to store the content and operation for generating the mark position table that stores the mark position information and the like.

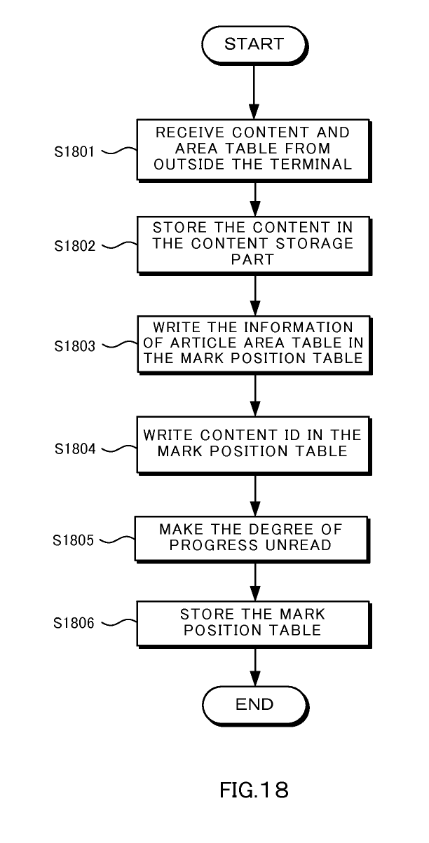

FIG. 18 is a flowchart illustrating operation for storing content and generating the mark position table. The outside data input part 109 receives content and area table 1702 from outside the terminal (step S1801). The content is set for a content ID assigned uniquely. The outside data input part 109 stores the content in the content storage part 101 (step S1802). Further, the outside data input part 109 delivers the content ID and area table 1702 to the table management part 106.

The table management part 106 reads the mark position table from the table storage part 107, and writes the information of the area table 1702 in the corresponding columns (item of the table of contents, first position, last position) of the mark position table (step S1803). Further, the table management part 106 writes the content ID in the content ID column in step S1804 in the written column, and writes “unread” in the degree of progress (S1805).

The table management part 106 stores a mark position table 1900 in the table storage part 107 (step S1806), and storage of the content is finished. Any particular operation is not performed on the mark position column of the mark position table 1900.

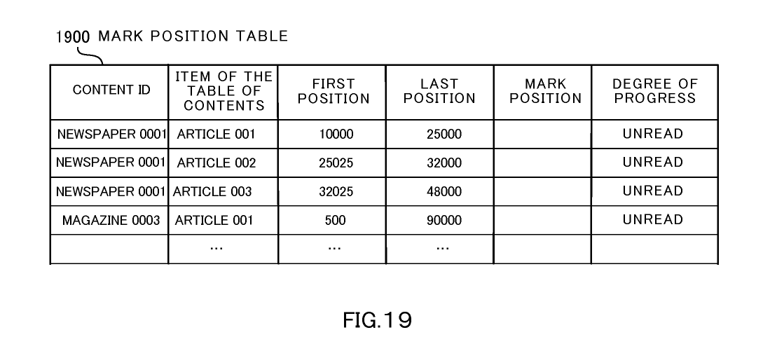

FIG. 19 is a diagram showing the mark position table. The mark position table 1900 has contents of the mark position table that is written when the content ID shown in FIG. 17 is stored as a newspaper 0001. The row in which the content ID is a magazine 0003 is generated because other content is stored and written. In addition, a single mark position table 1900 exists in the electronic book terminal 100, and is preferably generated when the terminal is manufactured or at the time of initial boot-up.

[Headline Display Generation]

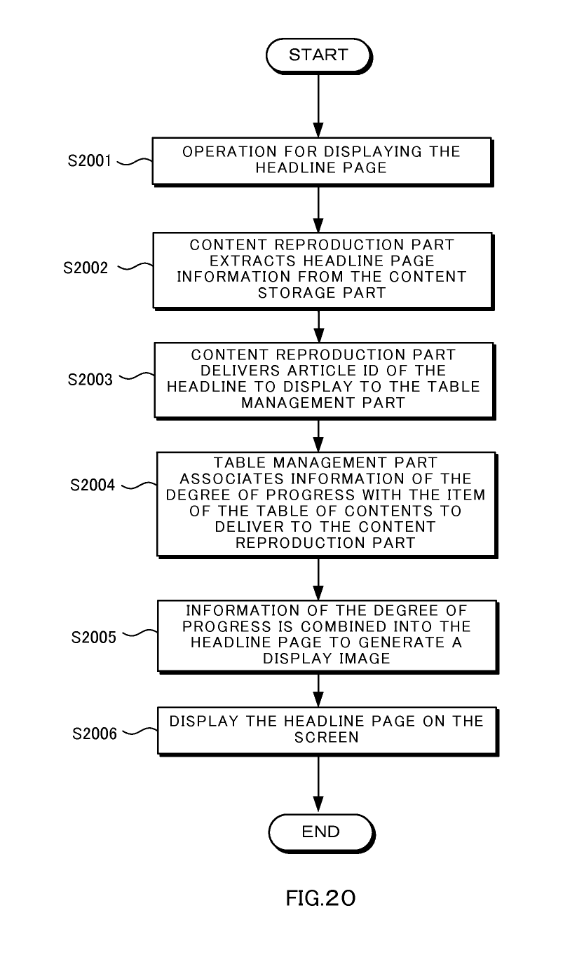

FIG. 20 is a flowchart illustrating operation for displaying progress of reproduction in a headline. As shown in FIG. 20, it is possible to display progress of reproduction in the headline of each article in the headline page. The operation input part 104 receives operation for displaying the headline page from the user (step S2001). The operation input part 104 instructs the content reproduction part 102 to display the headline page. The content reproduction part 102 extracts information of the headline page instructed from the content storage part 102 (step S2002).

The content reproduction part 102 determines an article ID displayed in the headline page from link information of the extracted headline page, and delivers the information to the table management part 106 (step S2003). Concurrently, the part 102 delivers information of the content ID. The table management part 106 reads the mark position table from the table storage part 107, extracts the degree of progress associated with the article ID of the content ID received from the content reproduction part 102, and associates the degree of progress with the article ID to deliver to the content reproduction part 102 (step S2004).

The content reproduction part 102 generates a combined image on the headline of the article associated with the degree of progress to deliver to the screen display part 103 (step S2005). The screen display part 103 displays the display image on the screen (step S2006).

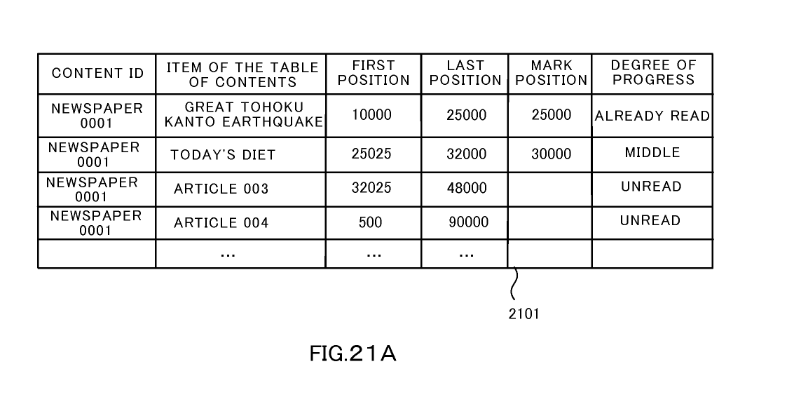

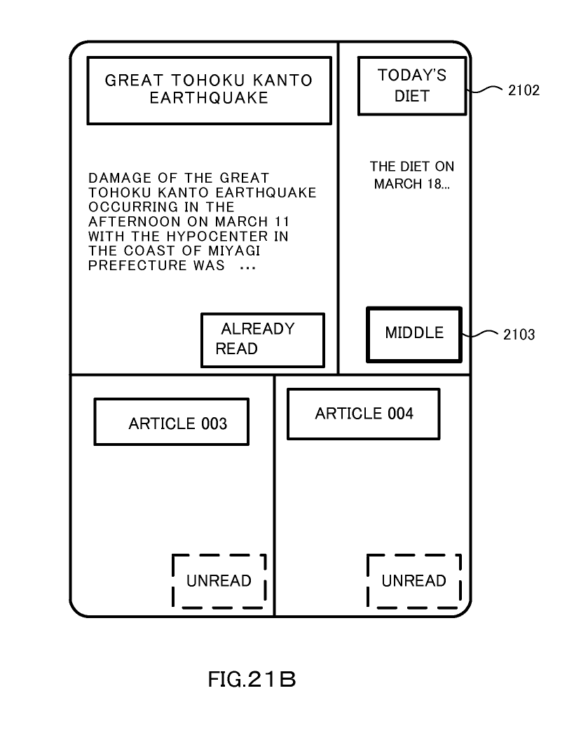

FIGS. 21(a) and 21(b) are diagrams showing examples of the mark position table and headline page display associated with the table, respectively. It is possible to display a headline page 2102 of the newspaper 0001 by using a mark position table 2101. As shown in FIG. 21, a degree of progress 2103 of the mark position table 2102 is displayed inside the headline of the associated article.

In addition, as described in Embodiment 1, as long as the information of the degree of progress is information that enables progress to be recognized, any display is available other than the above-mentioned example. For example, content of the degree of progress 2103 may be made display indicating the degree of progress such as percentage display and progress bar display. In the case of performing these kinds of display, it is necessary to calculate the degree of progress from the first position, last position and mark position of the mark position table in rewriting the degree of progress or displaying the headline page.

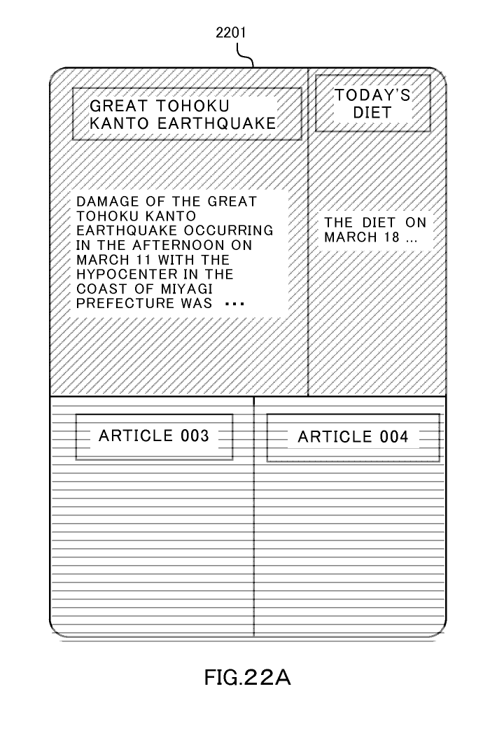

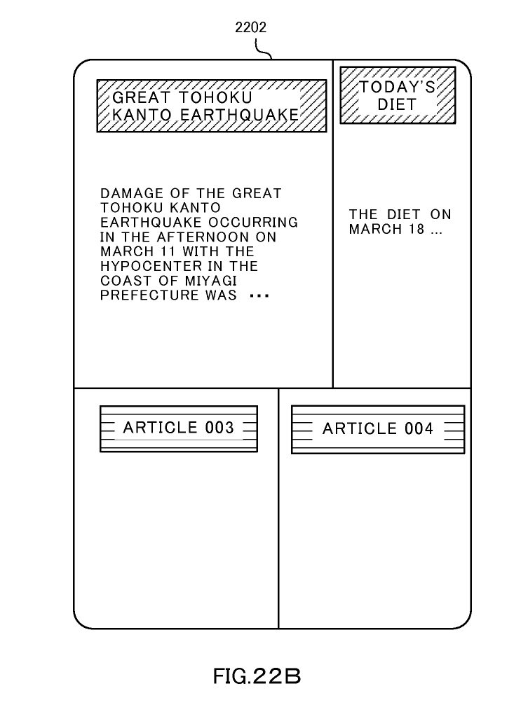

The degree of progress may be represented by coloring the whole or a part of the headline of the article. FIGS. 22(a) and 22(b) are diagrams showing display examples of reproduction progress display. Page display 2201 is a display example of coloring the entire article headline, and page display 2202 is a display example of coloring the title of the headline. For example, it is possible to color already read black, middle blue and unread red. Coloring may be a single color. A method of changing the concentration according to the degree of progress may be used.

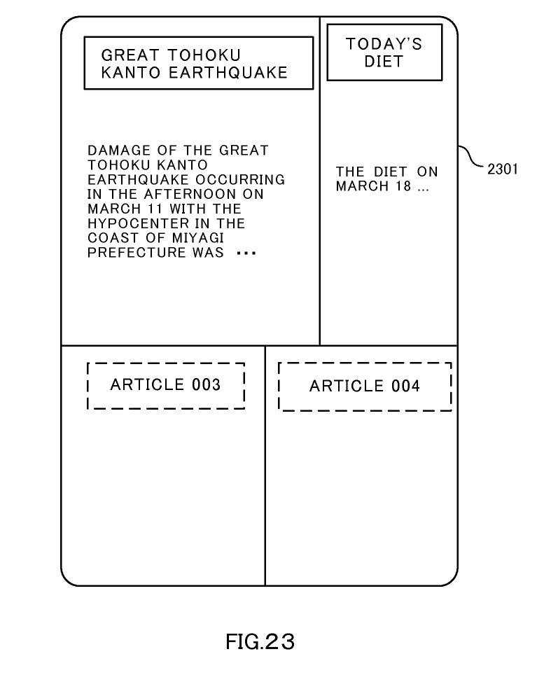

Further, FIG. 23 is a diagram showing a display example of reproduction progress display. As shown in FIG. 23, a color and/or size of a part or the whole of characters of the headline of the article may be changed according to the degree of progress. Reproduction progress display 2301 is a display example for changing the character color of the title of the article according to the degree of progress. For example, it is possible to display the already-read article in gray-out, the article in the middle of reproduction in a red color, and the unread article in blue. As the example of coloring, continuous color changes according to the degree of progress may be used.

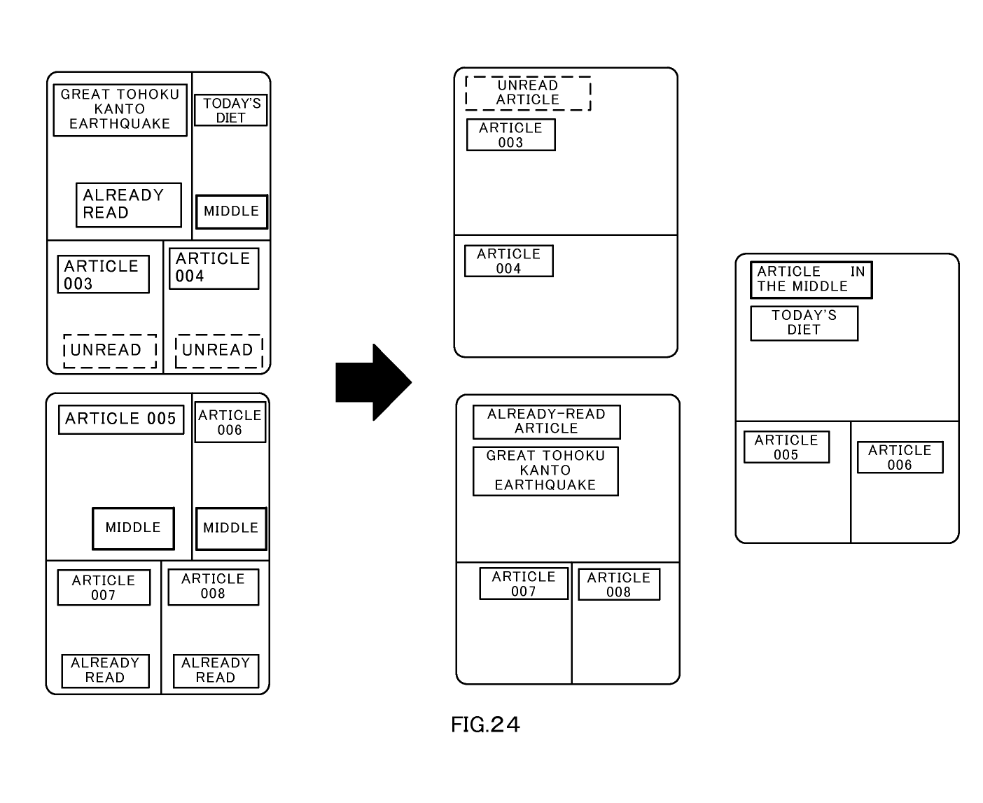

Further, FIG. 24 is a diagram showing another display example of reproduction progress display. As shown in FIG. 24, articles may be rearranged for each degree of progress to display pages of rearranged headlines. In the display example as shown in FIG. 24, in the case where unread articles, already-read articles and articles in a state of the middle exist in the content with eight articles, the electronic book terminal generates and displays three headline pages i.e. the headline page in which only headlines of the unread articles are collected, the head line page in which only headlines of the articles in the middle are collected, and the headline page in which only headlines of the already-read articles are collected. Between the headline pages is controlled to turn in receiving page turning operation or the like.

[Selection of the Table of Contents]

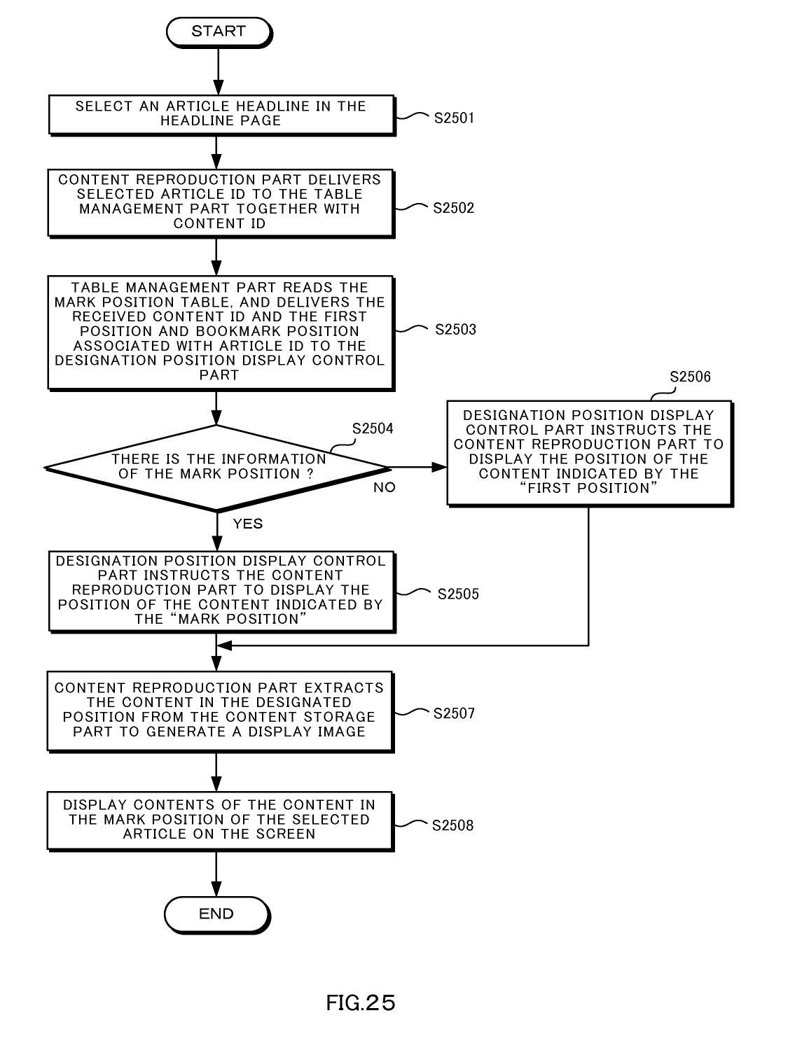

Described next is operation for selecting a headline of an article from the headline page to display the article. FIG. 25 is a flowchart illustrating operation after selecting an article in the headline page. The operation input part 104 receives selection of an article to display from the headline page from the user (step S2501). The operation input part 104 delivers information (coordinates on the screen or the like) of the selected position to the content reproduction part 102. The content reproduction part 102 determines the headline of the selected article from the selected position information, and delivers the article ID to the table management part 106 together with the content ID (step S2502).

The table management part 106 reads the mark position table from the table storage part 107, and delivers the content ID received from the content reproduction part 102, and information of the first position and mark position associated with the article ID to the designation position display control part 105 (step S2503). The designation position display control part 105 determines whether there is the received information of the mark position (step S2504). When there is the information of the mark position, the designation position display control part 105 instructs the content reproduction part 102 to display the position of the content indicated by the mark position (step S2505), while when there is not the information of the mark position (the case of receiving empty information, NULL or the like), instructing the part 102 to display the position of the content indicated by the first position (step S2506).

The content reproduction part 102 reads the information including the designated position of the content from the content storage part 101, and generates a display image to deliver to the screen display part 103 (step S2507). The screen display part 103 displays the received image on the screen (step S2508). Further, the content reproduction part 102 holds the article ID until display of the article is finished.

[Addition of the Mark Position]

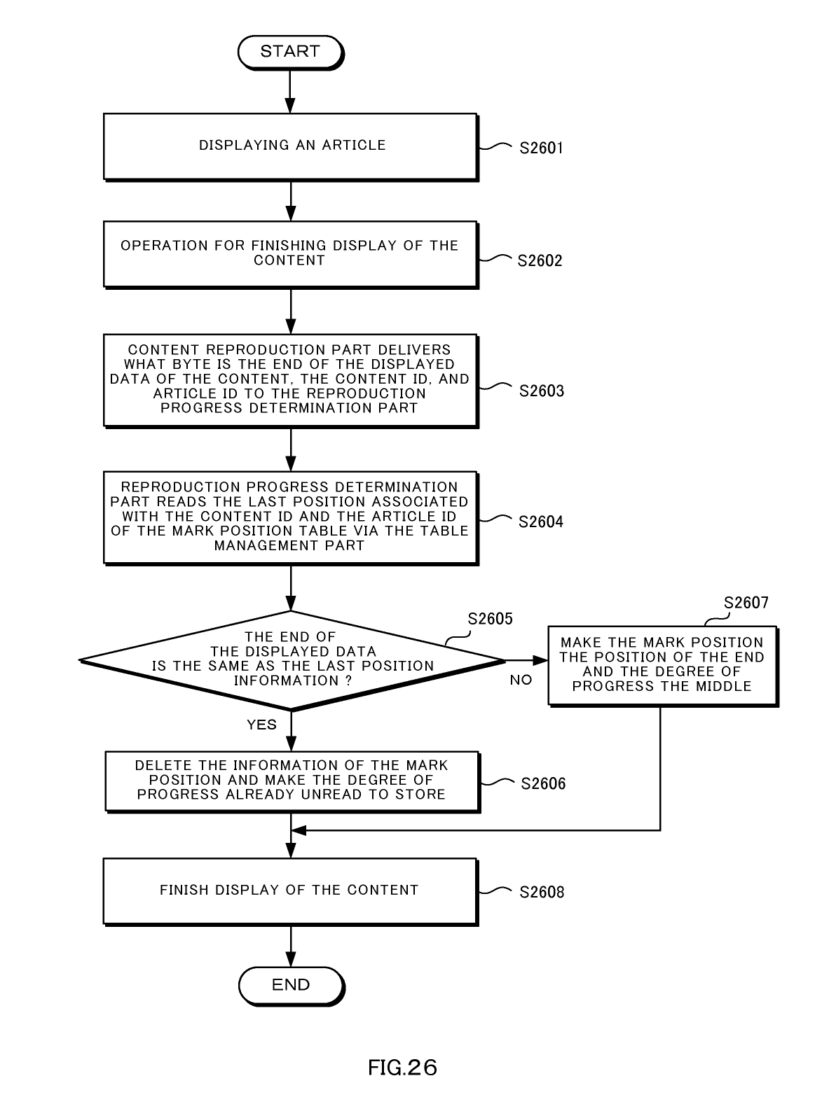

Described next is operation for adding the mark position in finishing display of the content. FIG. 26 is a flowchart illustrating operation for adding the mark position. First, the electronic book terminal 100 is displaying an article (step S2601). The user performs operation for finishing display of the content from the operation input part 104 (step S2602). The operation input part 104 delivers the instructions to the content reproduction part 102.

The content reproduction part 102 delivers the content ID, displayed article ID and position information indicating what byte of the content data is the end of the displayed data to the reproduction progress determination part 108 (step S2603).

The reproduction progress determination part 108 delivers the content ID and article ID to the table management part 106, and the table management part 106 delivers information of the last position of the article associated with the content ID and article ID of the mark position table to the reproduction progress determination part 108 (step S2604).

The reproduction progress determination part 108 compares the position information received from the content reproduction part 102 with the last position of the article described in the mark position table (step S2605). When the positions are the same, the reproduction progress determination part 108 delivers information for deleting the mark position and information for making the degree of progress already read to the table management part 106. The table management part 106 writes the mark position and the degree of progress in the row associated with the received content ID and article ID (step S2606).

In the case of determining that the positions are not the same, the reproduction progress determination part 108 instructs the table management part 106 to rewrite the mark position to the position information received from the content reproduction part 102 and further rewrite the degree of progress to the middle (step S2607). The table management part 106 similarly rewrites the mark position table.

Upon finishing rewriting the mark position table, the table management part 106 notifies the content reproduction part 102 of the finish of rewritten (step S2608), and the content reproduction part 102 finishes display of the content.

### DESCRIPTION OF SYMBOLS

100 Electronic book terminal (content reproduction apparatus)
101 Content storage part
102 Content reproduction part
103 Screen display part
104 Operation input part
105 Designation position display control part
106 Table management part
107 Table storage part
108 Reproduction progress determination part
109 Outside data input part
301 Screen display
302 Item of the table of contents
303 Reproduction progress display
304 Display image
500 Area table
501 Item of the table contents column
502 First page
503 Last page
600 ID table
601 Content ID column
602 Area table ID column
603 Mark position table ID column
700 Mark position table
701 Table of contents column
702 Mark position column
703 Degree of progress column
704 Table
705 Item of the table of contents column
706 Mark position column
707 Degree of progress column
1001 Screen display example
1002 Reproduction progress detail display
1003 Item of the table of contents
1004 Page area
1005 Mark position
1006 Display of the degree of reproduction progress
1007 Selection item to read from the mark position
1008 Selection item to read from the first
1501 Screen to display headlines
1502 Screen to display articles
1701 Data structure
1702 Area table
1703 Item of the table of contents
1704 First position
1705 Last position
1900, 2101 Mark position table
2102 Headline page
2103 Degree of progress
2201, 2202 Page display
2301 Reproduction progress display

1. A content reproduction apparatus that enables content to be reproduced from some midpoint, comprising:
a reproduction progress determination part that identifies a reproduction position in entire content which is divided into a plurality of areas as a mark position when a predetermined condition is met;
a table management part that manages a table for associating the identified mark position with an area including the reproduction position among the divided areas; and
a content reproduction part that reproduces the content from the reproduction position corresponding to the table when instructions for reproduction from the mark position are given.

2. The content reproduction apparatus according to claim 1, wherein when reproduction of content is finished, the reproduction progress determination part identifies a reproduction position at the time of the finish as a mark position.

3. The content reproduction apparatus according to claim 1, wherein when the reproduction position shifts out of the area that is currently reproduced, the reproduction progress determination part identifies a reproduction position immediately before the shift as a mark position.

4. The content reproduction apparatus according to claim 1, wherein the reproduction progress determination part identifies a degree of progress of reproduction within the divided area from the mark position in the divided area.

5. The content reproduction apparatus according to claim 4, wherein when reproduction of the content is finished, the reproduction progress determination part identifies a reproduction position at the time of the finish as a mark position, while identifying the degree of progress of reproduction within the divided area from the mark position at the time of the finish.

6. The content reproduction apparatus according to claim 4, wherein when the reproduction position shifts out of the area that is currently reproduced, the reproduction progress determination part identifies a reproduction position immediately before the shift as a mark position, while identifying the degree of progress of reproduction within the divided area from the reproduction position immediately before the shift.

7. The content reproduction apparatus according to claim 1, wherein the content reproduction part processes display due to reproduction of the content, and thereby performs reproduction progress display indicative of the degree of progress of the reproduction or the mark position for each divided area.

8. The content reproduction apparatus according to claim 7, wherein the content reproduction part adds the reproduction progress display onto display due to reproduction of the content to display.

9. The content reproduction apparatus according to claim 8, wherein the content reproduction part displays the divided areas on display of the table of contents of the content displayed due to reproduction of the content for each item of the table of contents, while performing the reproduction progress display for each item of the table of contents.

10. The content reproduction apparatus according to claim 9, further comprising:
an operation input part that receives operation for giving instructions for reproduction of the content,
wherein the operation input part receives operation for selecting the reproduction progress display, and the content reproduction part reproduces the content from the mark position associated with the selected reproduction progress display.

11. The content reproduction apparatus according to claim 7, wherein the content reproduction part changes a part of display due to reproduction of the content to perform the reproduction progress display.

12. The content reproduction apparatus according to claim 7, wherein the content reproduction part rearranges an arrangement of display due to reproduction of the content to perform the reproduction progress display.

13. A content reproduction method performed by a content reproduction apparatus to enable content to be reproduced from some midpoint, including the steps of:
identifying a reproduction position in entire content which is divided into a plurality of areas as a mark position when a predetermined condition is met;
managing a table for associating the identified mark position with an area including the reproduction position among the divided areas; and
reproducing the content from the reproduction position corresponding to the table when instructions for reproduction from the mark position are given.

14. A non-transitory computer-readable memory product storing a computer program, wherein said computer program is for causing a content reproduction apparatus to execute so as to enable content to be reproduced from some midpoint, including the processing of:
identifying a reproduction position in entire content which is divided into a plurality of areas as a mark position when a predetermined condition is met;
managing a table for associating the identified mark position with an area including the reproduction position among the divided areas; and
reproducing the content from the reproduction position corresponding to the table when instructions for reproduction from the mark position are given.
